(19) United States
(12) Patent Application Publication
(10) Pub. No.: US 2020/0041995 A1
(43) Pub. Date: Feb. 6, 2020

(54) Method for realtime remote-operation of self-driving cars by forward scene prediction.

(71) Applicant: Waymo LLC, Mountain View, CA (US)

(72) Inventor: Nathaniel Quillin, Mountain View, CA (US)

(21) Appl. No.: 16/597,454

(22) Filed: Oct. 9, 2019

Related U.S. Application Data
(60) Provisional application No. 62/743,988, filed on Oct. 10, 2018.

(51) Int. Cl. G05D 1/00

(52) U.S. Cl. CPC G05D 1/0022; G05D 2201/0213; G05D 1/0088; G05D 1/0044

(57) ABSTRACT

Examples described may enable provision of remote operation for a vehicle. An example method includes receiving sensor data from the vehicle. The method may further include determining a latency of a communication link. Additionally, the method may include providing at least one rendering to an operator based on the sensor data and the latency, where the rendering is based on a future location of the vehicle. The method may also include receiving an operator input. In response to the operator input, the method includes providing an instruction to the autonomous vehicle for execution by the autonomous vehicle based on the operator input via the communication link.

The present application claims priority to and is a non-provisional filing of U.S. Provisional Patent Application Ser. No. 62/743,988, filed on Oct. 10, 2018 the entire contents of which is herein incorporated by reference.

### BACKGROUND

A vehicle could be any wheeled, powered vehicle and may include a car, truck, motorcycle, bus, etc. Vehicles can be utilized for various tasks such as transportation of people and goods, as well as many other uses.

Some vehicles may be partially or fully autonomous. For instance, when a vehicle is in an autonomous mode, some or all of the driving aspects of vehicle operation can be handled by an autonomous vehicle system (i.e., any one or more computer systems that individually or collectively function to facilitate control of the autonomous vehicle). In such cases, computing devices located onboard and/or in a server network could be operable to carry out functions such as planning a driving route, sensing aspects of the vehicle, sensing the environment of the vehicle, and controlling drive components such as steering, throttle, and brake. Thus, autonomous vehicles may reduce or eliminate the need for human interaction in various aspects of vehicle operation.

### SUMMARY

In one aspect, the present application describes a method of providing remote operation for a vehicle. The method may include receiving sensor data from the vehicle. The method may further include determining a latency of a communication link. Additionally, the method may include providing at least one rendering to an operator based on the sensor data and the latency, where the rendering is based on a future location of the vehicle. The method may also include receiving an operator input. In response to the operator input, the method includes providing an instruction to the autonomous vehicle for execution by the autonomous vehicle based on the operator input via the communication link.

In another aspect, the present application describes a system. The system may include a communication unit configured to communicate with a vehicle via a communication link. The communication unit is configured to receive data from the vehicle, the data including image data and location data. The communication unit may also be configured to communicate instructions to the vehicle for execution by the vehicle. The system may also determine a latency of communication between the system and the vehicle. The system may also be configured to provide at least one rendering to an operator based on the data and the latency, where the rendering is based on a future location of the vehicle. The system may be further configured to receive signals based on an operator input. Additionally, the system may be configured to determine an instruction for the vehicle based on the operator input.

In still another aspect, the present application describes an article of manufacture including a non-transitory computer-readable medium having stored thereon instructions that, when executed by a processor in a computing system, causes the computing system to perform operations. The operations may include receiving sensor data from the vehicle. The operations may also include determining a latency of a communication link. The operations may further include providing at least one rendering to an operator based on the sensor data and the latency, where the rendering is based on a future location of the vehicle. Additionally, the operations may include receiving an operator input. In response to the operator input, the operations may yet further include providing an instruction to the autonomous vehicle for execution by the autonomous vehicle based on the operator input via the communication link.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE DRAWINGS

FIG. 1 is a functional block diagram illustrating a vehicle, according to an example implementation.

FIG. 2 is a conceptual illustration of a physical configuration of a vehicle, according to an example implementation.

FIG. 3A is a conceptual illustration of wireless communication between various computing systems related to an autonomous vehicle, according to an example implementation.

FIG. 3B shows a simplified block diagram depicting example components of an example computing system.

FIG. 4A illustrates a top view of a vehicle operating scenario, according to an example implementation.

FIG. 4B illustrates a sensor data representation of the scenario from FIG. 4A, according to an example implementation.

FIG. 4C illustrates a video feed taken from the vehicle in FIG. 4A, according to an example implementation.

FIG. 4D illustrates a simulated video feed displayed to a remote operator, according to an example implementation.

FIG. 4E illustrates a graphical user interface containing the sensor data representation from FIG. 4B and the simulated video feed from FIG. 4D along with a control system, according to an example implementation.

FIG. 4F illustrates the simulated video feed from FIG. 4D including a control menu, according to an example implementation.

FIG. 5 is a top view of a vehicle during operation, according to an example implementation.

FIG. 6 is a flow chart of a method, according to an example implementation.

FIG. 7 is a schematic diagram of a computer program, according to an example implementation.

### DETAILED DESCRIPTION

Example methods and systems are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein. Additionally, in this disclosure, unless otherwise specified and/or unless the particular context clearly dictates otherwise, the terms “a” or “an” means at least one, and the term “the” means at least one.

Furthermore, the particular arrangements shown in the Figures should not be viewed as limiting. It should be understood that other implementations might include more or less of each element shown in a given Figure. Further, some of the illustrated elements may be combined or omitted. Yet further, an example implementation may include elements that are not illustrated in the Figures.

In practice, an autonomous vehicle system may use data representative of the vehicle's environment to identify an object. The vehicle system may then use the object's identification as a basis for performing another action, such as instructing the vehicle to act in a certain way. For instance, if the object is a stop sign, the vehicle system may instruct the vehicle to slow down and stop before the stop sign, or if the object is a pedestrian in the middle of the road, the vehicle system may instruct the vehicle to avoid the pedestrian.

In some scenarios, vehicle control technology may implement a remote operator mechanism by which a remote operator may work in conjunction with the vehicle system to assist the vehicle system with controlling the vehicle. For example, remote operator may be able to remotely control the vehicle as it is driving. In this example, a remote operator may be able to send control signals to the vehicle to control and/or adjust the operating of the vehicle. The remote operator may be able to remotely drive the vehicle. The remote operator may have a vehicle cockpit to remotely operate the vehicle. The cockpit may include a steering wheel, gas pedal, brake pedal, and other control mechanisms.

In some implementations, a remote operation process may be triggered based on a variety of different criteria. In some examples, the remote operation process may be triggered based on an action the vehicle is going to perform. For example, a vehicle may transition from an autonomous operation mode to a human-driving (i.e., driver in the car driving) mode. During this transition, the remote operator may be able to remotely control the vehicle before the human driver takes over. In additional examples, the vehicle may operate in an autonomous mode and lose confidence in its operation. A remote operation process may take over.

During the remote operation process, a vehicle may communicate data wirelessly to a remote operation center. The sensor data may include video, pictures, radar data, laser imaging data, global positioning system (GPS) data, data related to vehicle parameters (e.g., speed, engine status, throttle position, etc.), and other data. The remote operations center may have a computer used by a remote operator to control the vehicle during the remote operation mode. The remote operation computer may be able to use the data communicated from the vehicle to create a display for the remote operator to aid in the remote operation of the vehicle.

In some examples, the remote operation system may be able to measure a latency of communication with the vehicle. Latency is the measure of the delay in communication between the remote operation computer and the vehicle. In some examples, the remote operation computer may be able to compensate for the latency. In order to compensate for the latency, the remote operation computer may be able to create a display for the remote operator that compensates for the latency. The compensation may include providing a display the predicts the location of objects and the view from the vehicle equal the to total latency of a round trip communication with the vehicle.

Mechanisms for remote operating, such as the autonomous to manual transition functionality described above, may be triggered in a variety of different ways. Accordingly, the present disclosure includes several methods of triggering and operating a remote operation mode of a vehicle.

The present disclosure provides methods and systems for remote operation in which the remote computing system is configured to operate the vehicle in a remote operation mode. Across the various different disclosed embodiments, the remote operation may be initiated by one or more trigger criteria or by a remote operator.

By way of example, an autonomous vehicle may generally operate without any input or instructions provided by the remote operator system. However, even though the autonomous vehicle may be operating without input from the remote operator system, the autonomous vehicle may continuously or periodically transmit data related to its environment to the remote operator system. For example, the autonomous vehicle may transmit images, sounds, and/or video recordings that were acquired by the vehicle's sensor system to the remote operator system. In some implementations, the remote operator system may store some or all of the data provided by the autonomous vehicle. In other implementations, the remote operator system may store only a specified amount of data or data related to a specified amount of time.

In response to the vehicle initiating remote operation (or the remote operator initiating vehicle control), the remote operator system may provide some or all of the stored data provided by the autonomous vehicle to the remote operator. The remote operation system may cause the display of images, representations, and/or video audio to the remote operator based on a latency of the communication between the vehicle and the remote operation system. The images, representations, and/or video may include predicted images, representations, and/or video based on a future position of the vehicle, based on the latency delay.

Example systems within the scope of the present disclosure will now be described in greater detail. An example system may be implemented in or may take the form of an automobile. However, an example system may also be implemented in or take the form of other vehicles, such as cars, trucks, motorcycles, buses, boats, airplanes, helicopters, lawn mowers, earth movers, snowmobiles, aircraft, recreational vehicles, amusement park vehicles, farm equipment, construction equipment, trams, golf carts, trains, trolleys, and robot devices. Other vehicles are possible as well.

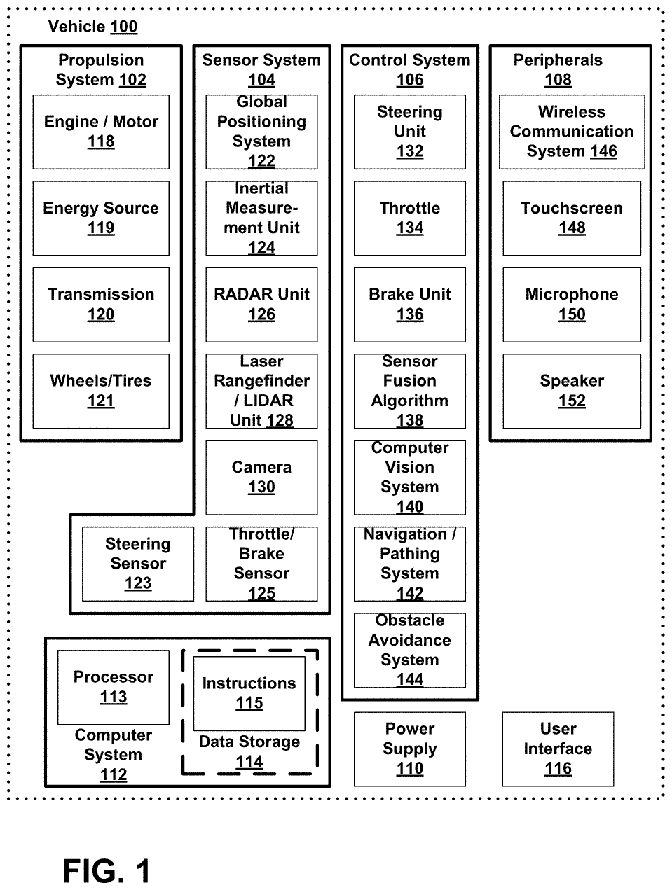

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. In some implementations, vehicle 100 may also include subsystems that enable a driver to control operations of vehicle 100.

As shown in FIG. 1, vehicle 100 may include various subsystems, such as propulsion system 102, sensor system 104, control system 106, one or more peripherals 108, power supply 110, computer system 112, data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, laser rangefinder/LIDAR 128, camera 130, steering sensor 123, and throttle/brake sensor 125, among other possible sensors. In some implementations, sensor system 104 may also include sensors configured to monitor internal systems of the vehicle 100 (e.g., 02 monitor, fuel gauge, engine oil temperature, brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the local environment of vehicle 100. As such, radar 126 may include antennas configured to transmit and receive radio signals. In some implementations, radar 126 may correspond to a mountable radar system configured to obtain measurements of the surrounding environment of vehicle 100.

Laser rangefinder/LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other implementations, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, roadway boundaries, etc.), and obstacles. As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the implementation, computer system 112 could be operable to monitor many aspects of vehicle 100 and its subsystems. In some implementations, computer system 112 may disable some or all functions of the vehicle 100 based on signals received from sensor system 104.

The components of vehicle 100 could be configured to work in an interconnected fashion with other components within or outside their respective systems. For instance, in an example implementation, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar unit 126 may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some implementations, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

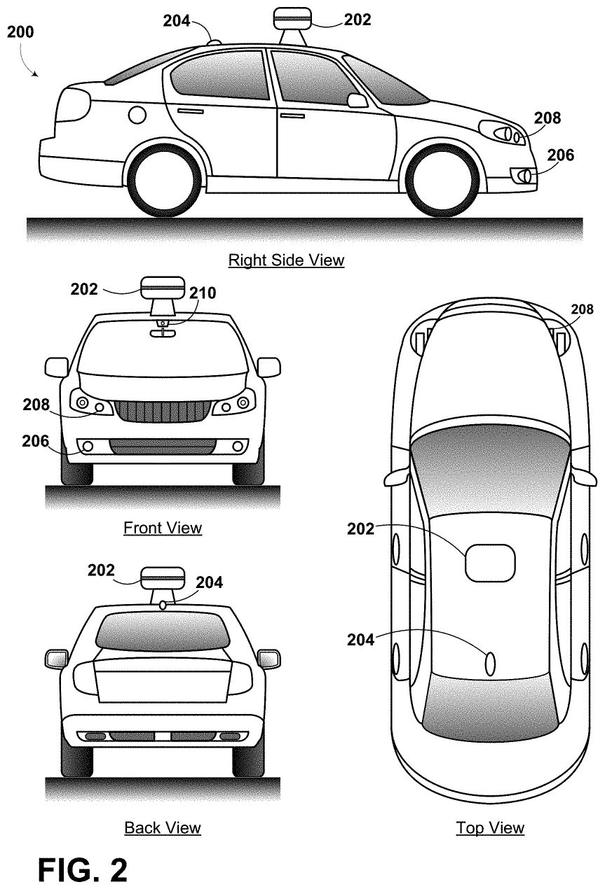

FIG. 2 depicts an example physical configuration of vehicle 200, which may represent one possible physical configuration of vehicle 100 described in reference to FIG. 1. Depending on the implementation, vehicle 200 may include sensor unit 202, wireless communication system 204, radio unit 206, deflectors 208, and camera 210, among other possible components. For instance, vehicle 200 may include some or all of the elements of components described in FIG. 1. Although vehicle 200 is depicted in FIG. 2 as a car, vehicle 200 can have other configurations within examples, such as a truck, a van, a semi-trailer truck, a motorcycle, a golf cart, an off-road vehicle, or a farm vehicle, among other possible examples.

Sensor unit 202 may include one or more sensors configured to capture information of the surrounding environment of vehicle 200. For example, sensor unit 202 may include any combination of cameras, radars, LIDARs, range finders, radio devices (e.g., Bluetooth and/or 802.11), and acoustic sensors, among other possible types of sensors. In some implementations, sensor unit 202 may include one or more movable mounts operable to adjust the orientation of sensors in sensor unit 202. For example, the movable mount may include a rotating platform that can scan sensors so as to obtain information from each direction around the vehicle 200. The movable mount of sensor unit 202 may also be moveable in a scanning fashion within a particular range of angles and/or azimuths.

In some implementations, sensor unit 202 may include mechanical structures that enable sensor unit 202 to be mounted atop the roof of a car. Additionally, other mounting locations are possible within examples.

Wireless communication system 204 may have a location relative to vehicle 200 as depicted in FIG. 2, but can also have different locations within implementations. Wireless communication system 200 may include one or more wireless transmitters and one or more receivers that may communicate with other external or internal devices. For example, wireless communication system 204 may include one or more transceivers for communicating with a user's device, other vehicles, and roadway elements (e.g., signs, traffic signals), among other possible entities. As such, vehicle 200 may include one or more vehicular communication systems for facilitating communications, such as dedicated short-range communications (DSRC), radio frequency identification (RFID), and other proposed communication standards directed towards intelligent transport systems.

Camera 210 may have various positions relative to vehicle 200, such as a location on a front windshield of vehicle 200. As such, camera 210 may capture images of the environment of vehicle 200. As illustrated in FIG. 2, camera 210 may capture images from a forward-looking view with respect to vehicle 200, but other mounting locations (including movable mounts) and viewing angles of camera 210 are possible within implementations. In some examples, camera 210 may correspond to one or more visible light cameras. Alternatively or additionally, camera 210 may include infrared sensing capabilities. Camera 210 may also include optics that may provide an adjustable field of view.

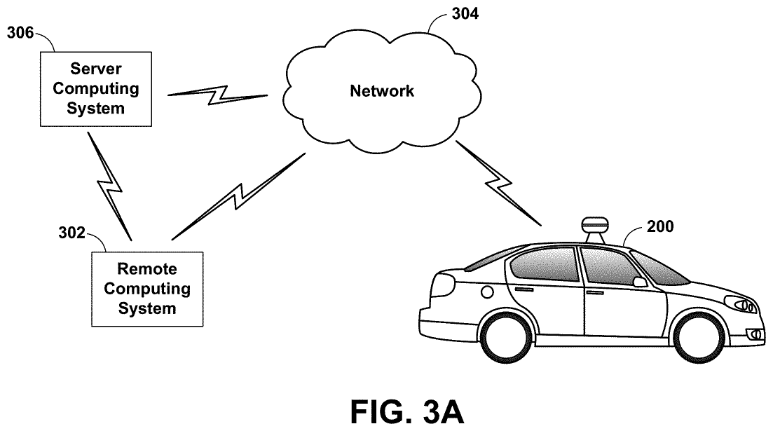

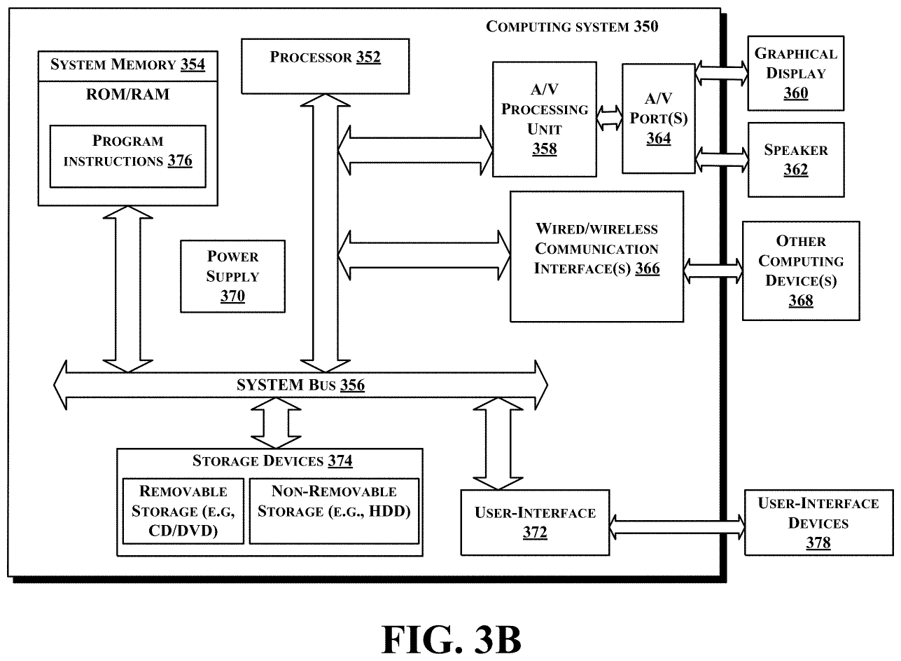

FIG. 3A is a conceptual illustration of wireless communication between various computing systems related to an autonomous vehicle, according to an example implementation. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous mode that enables a control system to safely navigate vehicle 200 between destinations using sensor measurements. When operating in an autonomous mode, vehicle 200 may navigate with or without passengers. As a result, vehicle 200 may pick up and drop off passengers between desired destinations.

Remote computing system 302 may represent any type of device related to remote operation techniques, including but not limited to those described herein. Within examples, remote computing system 302 may represent any type of device configured to (i) receive information related to vehicle 200, (ii) provide an interface through which a remote operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some implementations, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote operation thereof. As such, server computing system 306 may be configured to perform any operation(s), or portions of such operation(s), that is/are described herein as performed by remote computing system 302 and/or vehicle 200. Some implementations of wireless communication related to remote operation may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a remote computing system (e.g., remote computing system 302, or perhaps server computing system 306) may operate in a remote operation mode. In general, the remote operation mode may function as a means for a remote operator at a remote computing system to provide remote operation of the vehicle by accessing information previously obtained by the vehicle. The remote computing system may enable a remote operator to provide this support in real-time or approximately real-time.

In some implementations, to facilitate remote operation, a vehicle (e.g., vehicle 200) may receive data representing objects in an environment in which the vehicle operates (also referred to herein as “environment data”) in a variety of ways. A sensor system on the vehicle may provide the environment data representing objects of the environment. For example, the vehicle may have various sensors, including a camera, a radar unit, a laser range finder, a microphone, a radio unit, and other sensors. Each of these sensors may communicate environment data to a processor in the vehicle about information each respective sensor receives.

In one example, a camera may be configured to capture still images and/or video. In some implementations, the vehicle may have more than one camera positioned in different orientations. Also, in some implementations, the camera may be able to move to capture images and/or video in different directions. The camera may be configured to store captured images and video to a memory for later processing by a processing system of the vehicle. The captured images and/or video may be the environment data.

In another example, a radar unit may be configured to transmit an electromagnetic signal that will be reflected by various objects near the vehicle, and then capture electromagnetic signals that reflect off the objects. The captured reflected electromagnetic signals may enable the radar system (or processing system) to make various determinations about objects that reflected the electromagnetic signal. For example, the distance and position to various reflecting objects may be determined. In some implementations, the vehicle may have more than one radar unit in different orientations. The radar system may be configured to store captured information to a memory for later processing by a processing system of the vehicle. The information captured by the radar system may be environment data.

In another example, a laser range finder may be configured to transmit an electromagnetic signal (e.g., light, such as that from a gas or diode laser, or other possible light source) that will be reflected by a target objects near the vehicle. The laser range finder may be able to capture the reflected electromagnetic (e.g., laser) signals. The captured reflected electromagnetic signals may enable the range-finding system (or processing system) to determine a range to various objects. The range-finding system may also be able to determine a velocity or speed of target objects and store it as environment data.

Additionally, in an example, a microphone may be configured to capture audio of environment surrounding the vehicle. Sounds captured by the microphone may include emergency vehicle sirens and the sounds of other vehicles. For example, the microphone may capture the sound of the siren of an emergency vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some implementations it is desirable to transmit the first electromagnetic radiation signal with a signaling mode that requests a response from devices located near the autonomous vehicle. The processing system may be able to detect nearby devices based on the responses communicated back to the radio unit and use this communicated information as a portion of the environment data.

In some implementations, the processing system may be able to combine information from the various sensors in order to make further determinations of the environment of the vehicle. For example, the processing system may combine data from both radar information and a captured image to determine if another vehicle or pedestrian is in front of the autonomous vehicle. In other implementations, other combinations of sensor data may be used by the processing system to make determinations about the environment.

While operating in an autonomous mode, the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc.

In some examples, a vehicle may operate in a fully autonomous mode, such as driving on a highway. When the vehicle is exiting the highway, it may transition from an autonomous operation mode into a human operation mode. To aid in the transition, a remote operator may take control of the vehicle and control its operation from a remote terminal. For example, as the vehicle is approaching the highway exit, the autonomous system may hand off control of the vehicle to the remote operator. The remote operator may drive the vehicle until a human operator can take over driving control.

In various examples, the remote operator may remotely operate the vehicle when transitioning from an autonomous operation mode into a human operation mode, when transitioning from a human operation mode into an autonomous operation mode, during an autonomous operation mode, or any other circumstance where remote driving may be advantageous. In some examples, when the remote operator takes control of the vehicle, the operation may be transparent to occupants of the vehicle. In this example, from the occupants' perspective, it may appear the vehicle is still operating in an autonomous mode. In other examples, when the remote operator takes control of the vehicle, there may be an alert provided to the occupants of the vehicle instructing them that the vehicle is attempting to transition to human-drive mode.

Additionally, the remote operation system may also provide the remote operator with a display to enable the remote operation of the vehicle. The display may correspond to what a driver of the vehicle may see from the driver's seat of the vehicle. In some examples, the remote operation system may create a simulated display. The simulated display may be based off of a latency in communication between the vehicle and the remote operation system. Therefore, the objects in the display may appear where the remote operation system expects them to be when the control signal from the remote operation system is received by the vehicle. By showing a simulated display, the remote operator may provide inputs as if the remote operator was driving the vehicle inside of the vehicle.

In some examples, the remote operation system may also include a simulated cockpit that may include a steering wheel, gas pedal, brake pedal, and other control mechanisms. The remote operator may be able to control the vehicle through using the various inputs of the simulated cockpit. Thus, due to the simulated display, the remote operator may be able to drive the vehicle as if he or she was in the driver's seat of the vehicle.

In another example, the vehicle may operate in autonomous mode and transition to a remote human operated mode based on the autonomous driving system not being able to identify objects correctly, or have a low confidence in object identification. When a processing system in the vehicle identifies objects near the vehicle, the vehicle may be able to autonomously change velocity, or alter the movement in another way. However, when the vehicle detects an object but is not highly confident in the detection of the object, the vehicle can request a remote operator to remotely operate the vehicle. Remote operation tasks may also include the remote operator providing an instruction to control operation of the vehicle (e.g., instruct the vehicle to stop at a stop sign if the remote operator determines that the object is a stop sign).

To facilitate this, the vehicle may analyze the environment data representing objects of the environment to determine at least one object having a detection confidence below a threshold. A processor in the vehicle may be configured to detect various objects of the environment based on environment data from various sensors. For example, in one implementation, the processor may be configured to detect objects that may be important for the vehicle to recognize. Such objects may include pedestrians, street signs, other vehicles, indicator signals on other vehicles, and other various objects detected in the captured environment data.

The detection confidence may be indicative of a likelihood that the determined object is correctly identified in the environment, or is present in the environment. For example, the processor may perform object detection of objects within image data in the received environment data, and determine that the at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the environment in various way depending on the source of the environment data. In some implementations, the environment data may come from a camera and be image or video data. In other implementations, the environment data may come from a LIDAR unit. The vehicle may analyze the captured image or video data to identify objects in the image or video data. The methods and apparatuses may be configured to monitor image and/or video data for the presence of objects of the environment. In other implementations, the environment data may be radar, audio, or other data. The vehicle may be configured to identify objects of the environment based on the radar, audio, or other data.

In some implementations, the techniques the vehicle uses to detect objects may be based on a set of known data. For example, data related to environmental objects may be stored to a memory located in the vehicle. The vehicle may compare received data to the stored data to determine objects. In other implementations, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other implementations, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some implementations, the vehicle may react as if the detected object is present despite the low confidence level. In other implementations, the vehicle may react as if the detected object is not present.

When the vehicle detects an object of the environment, it may also calculate a confidence associated with the specific detected object. The confidence may be calculated in various ways depending on the implementation. In one example, when detecting objects of the environment, the vehicle may compare environment data to predetermined data relating to known objects. The closer the match between the environment data to the predetermined data, the higher the confidence. In other implementations, the vehicle may use mathematical analysis of the environment data to determine the confidence associated with the objects.

In response to determining that an object has a detection confidence that is below the threshold, the vehicle may transmit, to the remote computing system, a request for remote operation with the identification of the object. As discussed above, the remote computing system may take various forms, as an example, the remote computing system may be a remote computer terminal or other device that is located at a location that is not near the vehicle.

The request for remote operation may include the environment data that includes the object, such as image data, audio data, etc. The vehicle may transmit the environment data to the remote computing system over a network (e.g., network 304), and in some implementations, via a server (e.g., server computing system 306). The remote operator of the remote computing system may in turn use the environment data as a basis for responding to the request.

In some implementations, the vehicle and/or another computing entity may include as part of the environment data, a bounding box provided substantially around the object whose identification is at issue (e.g., image data with a box around the object). As such, when the remote computing system receives the environment data, the remote computing system may provide the environment data, including the object in the bounding box or bounding region, for display to the remote operator so that the remote operator can readily and quickly identify the object in the environment data. By identifying the objection, the remote operator may be able to more quickly and accurately determine the correct course of action for the remote operation of the vehicle.

In some implementations, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of vehicle (e.g., a speed and/or direction), among other possible adjustments. At the same time, or perhaps at a later time, the vehicle may also request remote operation to correctly operate the vehicle near the object having a low detection confidence.

In other implementations, even if the vehicle detects an object having a confidence that meets or exceeds the threshold, the vehicle may operate in accordance with the detected object (e.g., come to a stop if the object is identified with high confidence as a stop sign), but may be configured to request remote operation at the same time as (or at a later time from) when the vehicle operates in accordance with the detected object. As a variation of the example above, if the vehicle detects a sign that the vehicle identifies as a sign that reads “40 kilometers per hour,” and the sign is detected as having a confidence at or above the confidence threshold, the vehicle may begin operating in accordance with the detected object (e.g., adjust its speed to 40 kilometers per hour). At the same time, or perhaps at a later time, the vehicle may also request remote operation to ensure correct operation. The remote operation in these other implementations may serve as a precaution or may serve other purposes. The vehicle may be configured to operate in this manner for certain types of objects, such as objects that are more important to vehicle and pedestrian safety (e.g., stop signs, traffic lights, crosswalks, and pedestrians).

When receiving the environment data, the remote computing system may store the data in preparation for receiving a remote operation request. The images, sounds, and/or video recordings that were acquired by the vehicle's sensor system may be stored in a memory of the remote operation system. When stored in the memory of the remote operation system, the data may be labeled with the vehicle that transmitted the data to the remote operation system. Thus, when the vehicle requests remote operation, the remote operation system may be able to retrieve data previously transmitted to the remote operation system. The remote operation system may store some or all of the data provided by the autonomous vehicle. Additionally, the remote operation system may store only a specified amount of data or data related to a specified amount of time and/or distance traveled. For example, the remote operation system may only store the data for a period of time, such as 5 minutes. After the 5-minute period of time, the remote operation system may delete some or all of the data. In other examples, the remote operation system may only store the data for a predetermined distance, such as 200 meters.

While the autonomous vehicle operates, there may be situations where the vehicle is stopped for an extended period of time. For example, the autonomous vehicle may stopped on the side of a road to wait for passengers to load and/or unload. The autonomous vehicle may stop in a parking spot, double park, wait in a loading zone, and/or stop in another location. In these instances, relevant data may be based on the distance traveled rather than a predetermined amount of time. After the 5-minute period of time, the remote operation system may delete some or all of the data. In practice, the remote operation system may remove the label of which autonomous vehicle transmitted the data after the period of time. By removing the label, the data is no longer identifiable to a specific vehicle. In some other examples, the remote operation system may remove a different portion of the data after the period of time.

When remote operation is requested, the remote operation system may present the remote operator with some or all of the environment data. As previously discussed, the data presented to the operator may correspond to a simulated display. The simulated display may be based off of a latency in communication between the vehicle and the remote operation system. In some examples, when remote operation is requested the operator may receive data in real-time from the vehicle (or close to real time, including some latency).

The remote computing system may present the environment data in a simulated form based on the latency. For example, the remote computing system may display, on a touchscreen, a graphical user interface (GUI) a simulated view based on the expected changes to the environment based on the latency. Additionally or alternatively, the remote computing system may play, via a speaker of the remote computing system, audio representative of sounds of the environment of the vehicle (e.g., a siren sound from what may be an ambulance).

To enable the remote operator to provide input relating to the environment data, and thereby effectively respond to the request for remote operation, the remote computing system may include an interface for receiving input, such as a keyboard, touchscreen, mouse, touchpad, microphone, etc and/or a vehicle control system based on a vehicle's cockpit.

Additionally or alternatively, in other implementations, the remote computing system may be configured to enable the remote operator to provide an input representative of an instruction to control the vehicle. For example, if the remote operator perceives the environment data to include an image of a merge sign, the remote operator may input an instruction to control the vehicle to merge from one lane to another in a safe manner.

In some implementations, the remote computing system may enable the remote operator to perform other actions in order to correctly operate the vehicle. For example, if the object at issue is an orange construction cone (or other construction-related object), the remote operator may remotely take control of the vehicle and operate it safely through the construction zone. As another example, a roadway may have non-standard markings, the remote operator may control the vehicle to operate safely in the area with non-standard markings. Other examples are possible as well.

While the remote operator is controlling the vehicle, the remote computing system may transmit, to the vehicle, remote operation data that includes a representation of the human operator's input. The remote operation data may include control signals for the vehicle. The control signals may responsively control the vehicle and may include brake, accelerator, steering, turn signal, and other control signals. The remote computing system may transmit the remote operation data wirelessly or by some other manner.

Upon receipt of the remote operation data by the vehicle the vehicle may execute the control instructions. For example, the vehicle may alter its movement, such as by stopping the vehicle, switching the vehicle to a human-controlled mode, changing a velocity of vehicle (e.g., a speed and/or direction), and/or another movement alteration based on the control signals. The vehicle may execute the control signals as soon as the control signals are received. By executing the control signals quickly after they are received, the remote operator may be able to drive the vehicle remotely in a natural manner.

FIG. 3B shows a simplified block diagram depicting example components of an example computing system 350. This example computing system 306 could correspond to the remote computing system 302 and/or the server computing system 306 shown in FIG. 3A.

Computing system 350 may include at least one processor 352 and system memory 354. In an example embodiment, computing system 350 may include a system bus 356 that communicatively connects processor 352 and system memory 354, as well as other components of computing system 350. Depending on the desired configuration, processor 352 can be any type of processor including, but not limited to, a microprocessor (μP), a microcontroller (μC), a digital signal processor (DSP), or any combination thereof. Furthermore, system memory 354 can be of any type of memory now known or later developed including but not limited to volatile memory (such as RAM), non-volatile memory (such as ROM, flash memory, etc.) or any combination thereof.

An example computing system 350 may include various other components as well. For example, computing system 350 includes an A/V processing unit 358 for controlling graphical display 360 and speaker 362 (via A/V port 364), one or more communication interfaces 366 for connecting to other computing devices 368, and a power supply 370. Graphical display 360 may be arranged to provide a visual depiction of various input regions provided by user-interface module 372. For example, user-interface module 372 may be configured to provide a user-interface, and graphical display 360 may be configured to provide a visual depiction of the user-interface. User-interface module 372 may be further configured to receive data from and transmit data to (or be otherwise compatible with) one or more user-interface devices 378.

Furthermore, computing system 350 may also include one or more data storage devices 374, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium now known or later developed that can be used to store the desired information and which can be accessed by computing system 300.

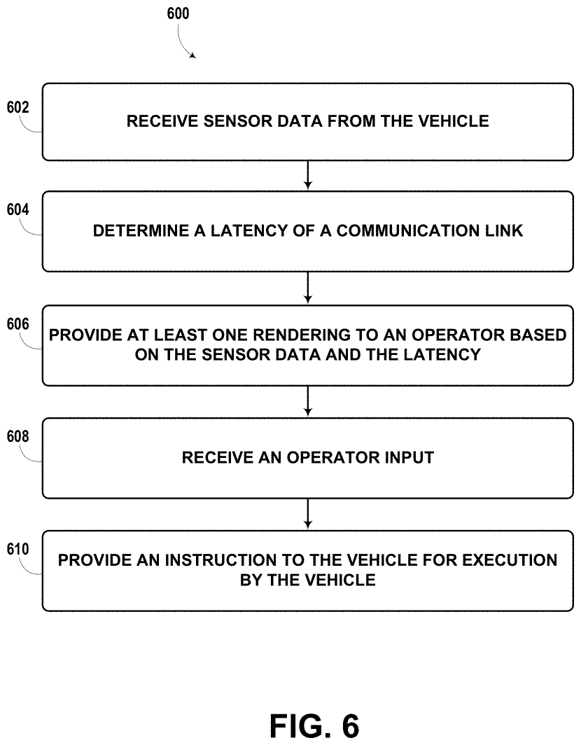

According to an example embodiment, computing system 350 may include program instructions 376 that are stored in system memory 354 (and/or possibly in another data-storage medium) and executable by processor 352 to facilitate the various functions described herein including, but not limited to, those functions described with respect to FIG. 6. Although various components of computing system 350 are shown as distributed components, it should be understood that any of such components may be physically integrated and/or distributed according to the desired configuration of the computing system.

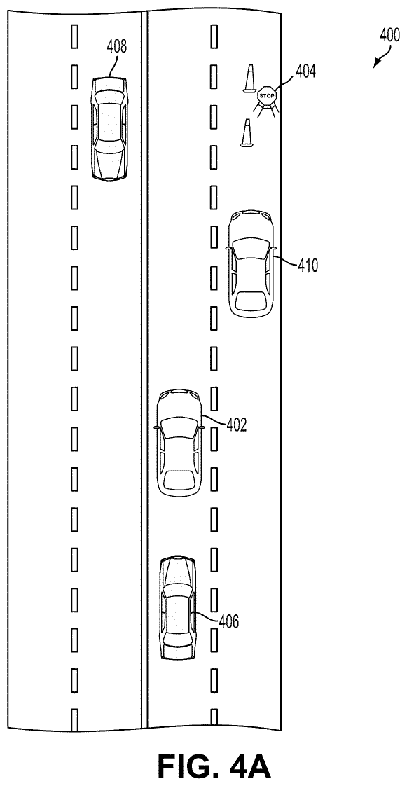

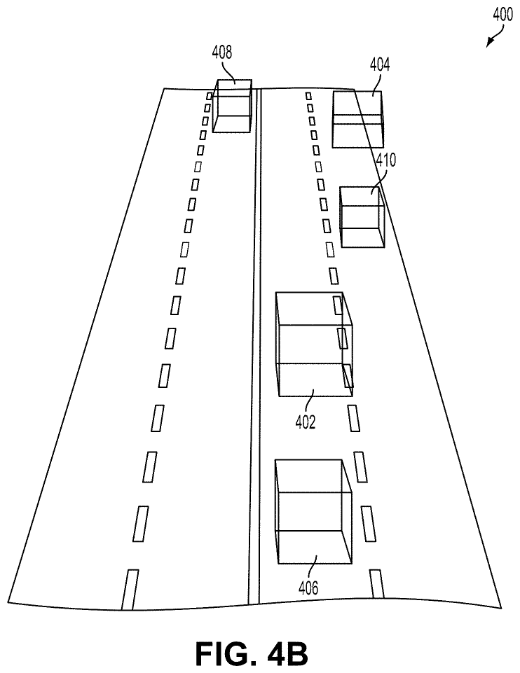

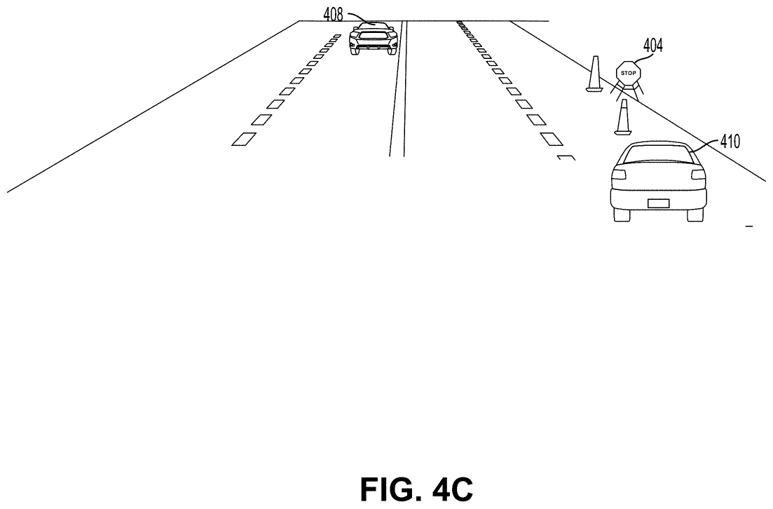

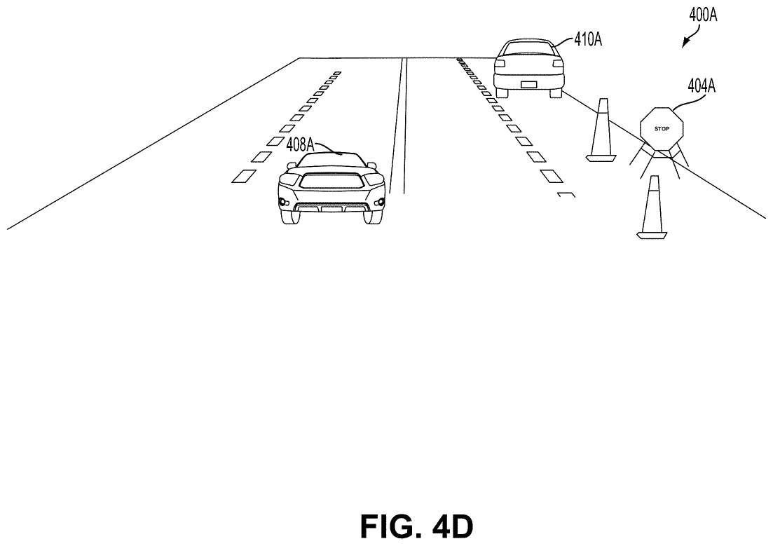

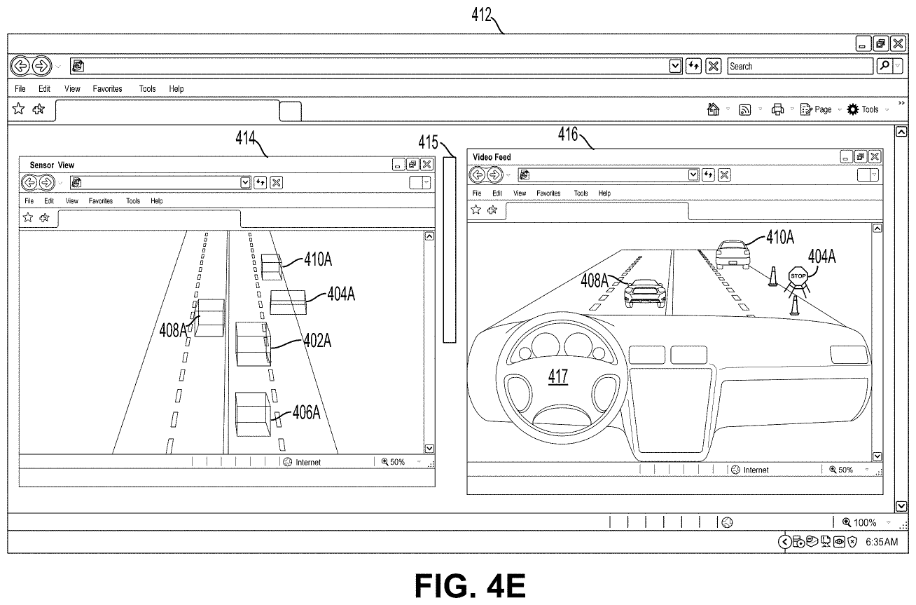

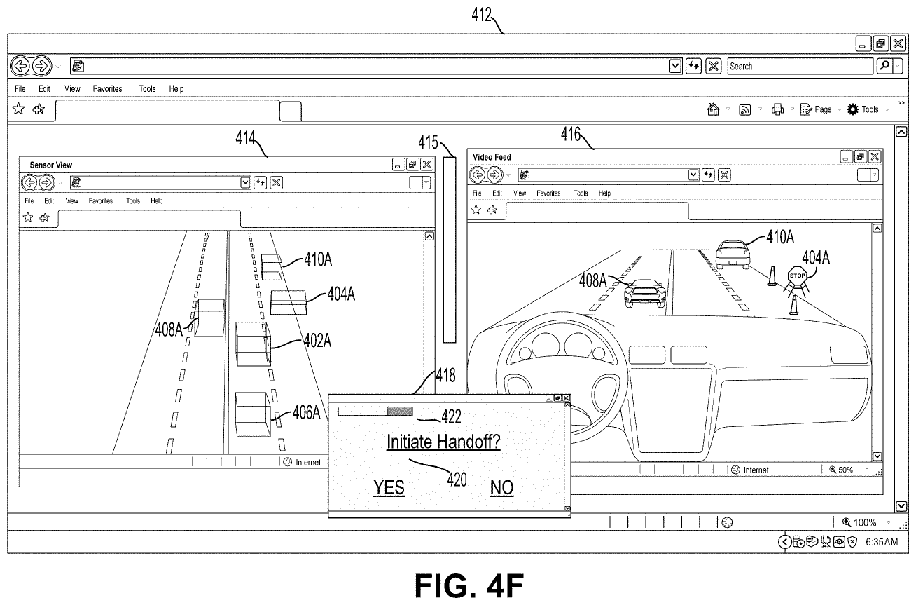

FIG. 4A illustrates a top view of a scenario encountered by an autonomous vehicle, in accordance with an example implementation. As shown, an autonomous vehicle 402 may be operating within an environment 400 containing other vehicles 406, 408, and 410. The autonomous vehicle 402 may be operating in an autonomous mode with a lane of travel when it approaches an obstacle in the road, in this example a temporary stop sign 404.

While the following description relates to a temporary sign, it is equally applicable in any situation where remote operation may be advantageous. As previously discussed, other remote operation situations may include lane merging, exiting or entering a highway, low detection confidence of an object, low confidence in performing an action for a situation, or any other situation where remote operation may be desirable.

The autonomous vehicle 402 may create a representation of its environment 400 based on any combination of possible types of sensor data as described above. FIG. 4B illustrates a representation of the environment from FIG. 4A based on sensor data collected by the vehicle, according to an example implementation. In some examples, the representation may not be a perfect copy of the environment. For instance, some of the sensors may be blocked in certain directions or some of the sensor data may be distorted. Additionally, some objects may be abstracted into geometric shapes, such as the representations of the vehicles 406, 408, and 410 or the temporary stop sign 404 shown in the figure. The autonomous vehicle 402 may identify objects or other aspects of the environment with varying levels of precision.

The situation depicted in FIG. 4A and FIG. 4B may be a situation in which the vehicle's confidence level drops below a predetermined threshold level. The drop in confidence level may be based on one or more different factors about the vehicle's operation and/or the vehicle's view of the environment. For example, the vehicle 402 may not be able to create a complete sensor representation of its environment because the temporary stop sign 404 may be obstructing its views of aspects of the environment (e.g., other cars). Additionally, the vehicle 402 may not be able to identify with confidence one or more objects within the environment, possibly including the temporary stop sign 404. Also, aspects of the vehicle's own operation may also cause its confidence level to drop. For instance, the vehicle may have stopped behind the temporary stop sign 404, and may have remained stuck there for a certain period of time, which may trigger a warning from one of the vehicle's systems. In some examples, if the vehicle 402 is stuck for more than a predetermined set amount of time (e.g., 1 minute or 5 minutes), its confidence level may begin to drop. Other factors may contribute to the vehicle's determination that its confidence in how to proceed (e.g., whether to continue waiting or to do something else) has fallen to a level where the vehicle should request remote operation.

FIG. 4C shows a video stream of the environment 400 of autonomous vehicle 402 from the point-of-view of the autonomous vehicle 402. For example, the autonomous vehicle 402 may be equipped with one or more video cameras which capture video streams of a portion of the environment 400. This environment data may be transmitted along with the request with assistance for use by the human operator. In this example, the portion of the environment 400 captured in the video stream includes the temporary stop sign 404 as well as cars 408 and 410. In some examples, the cameras (or other sensors) may be moveable (and possibly may be controlled directly or indirectly by a remote operator) in order to capture video of additional portions of the environment 400 in order to resolve certain scenarios. Additional data may be provided to the remote operation system once the camera or other sensor is moved.

FIG. 4D illustrates a simulated video feed displayed to a remote operator, according to an example implementation. The simulated video stream of the environment 400A of autonomous vehicle 402 from the point-of-view of the autonomous vehicle 402 including the change of position of various objects based on the latency time. As discussed with respect to FIGS. 4A-4C, the autonomous vehicle 402 may be equipped with one or more video cameras which capture video streams of a portion of the environment 400 and relay the video to the remote operation system. As part of the transmission, the vehicle may communicate a latency measure to the remote operation system. In some other examples, the remote operation system may measure or determine latency on its own. Based on the latency, the remote operation system may simulate a video feed based on the predicted position of objects at a future time. The future time may be equal to, or approximately equal to, the round trip latency between the vehicle and the remote operation system.

In this example, the simulated video stream of the environment 400A includes the temporary stop sign 404A as well as cars 408A and 410A. Compared to FIG. 4C, which was a live view from the vehicle 402, the temporary stop sign 404A and cars 408A and 410A are advanced in their positions based on the latency. For example, temporary stop sign 404A is shown closer because vehicle 402 is driving toward it. Car 408A is shown closer as it is driving toward vehicle 402 as well. Car 410A is shown further away, as it may be driving at a higher speed than vehicle 402. FIG. 4D shows one possible example of a simulated field of view.

FIG. 4E shows an example GUI 412 on a remote computing system that may be presented to a human operator. The remote computing system of FIG. 4E also includes a cockpit 417 that may include a steering wheel, gas pedal, brake pedal, and other control mechanisms. The cockpit 417 may also include a gauge cluster that show various operating parameters of the vehicle, such as a speedometer, etc. The cockpit 417 may allow the remote operator to drive the vehicle 402 as if the remote operator was sitting in the vehicle. The GUI 412 may include a latency indicator 415. The latency indicator 415 may be a latency bar that fills as latency increases. In other examples, the latency indicator 415 may show a numerical indication of the latency. In yet other examples, the latency indicator 415 may change color depending on the latency.

The GUI 412 may include separate sub-windows 414 and 416. The first sub-window 414 may include simulated vehicle sensor data representation of its environment, such as described above with respect to FIG. 4B. The sensor data shown in FIG. 4E may also be simulated sensor data based on the latency of communication. The second sub-window 416 may include a simulated video stream of a portion of the environment, such as described above with respect to FIG. 4D. However, in some examples, the two displays may not both show simulated data. In some examples, one window may be live data while the other window shows simulated data.

Accordingly, the remote operator may be able to drive the vehicle from the remote computing system using the cockpit 417 and the simulated display 416. The simulated display 416 make is seem as if the remote operator is driving the vehicle from within the vehicle.

The remote operator may be presented with a GUI that contains a control menu that enables a remote operator to send a handoff request to the vehicle. For example, FIG. 4F shows an example GUI that contains a first sub-window showing the simulated vehicle sensor data representation of its environment and a second sub-window showing a simulated video stream of a portion of the vehicle's environment, such as described above with respect to FIG. 4E. FIG. 4F additionally contains an example control menu 418 that may allow a human operator to initiate a handoff to human control of the vehicle by a driver in the vehicle. In some examples the remote operated may trigger a handoff, in other examples, the vehicle or a driver may trigger a handoff. In some further examples, a handoff may be triggered based on map data. For example, a handoff may be triggered based on a route of the vehicle and the associated map data. In one example, a handoff may be triggered based on the vehicle merging on to or off of a highway.

In other examples, the control menu 418 may allow the operator to input guidance to the vehicle in a number of different ways (e.g., selecting from a list of operations, typing in a particular mode of operation, selecting a particular region of focus within an image of the environment, etc.). Thus, control menu 418 may be used to drive the vehicle remotely in some instances as well.

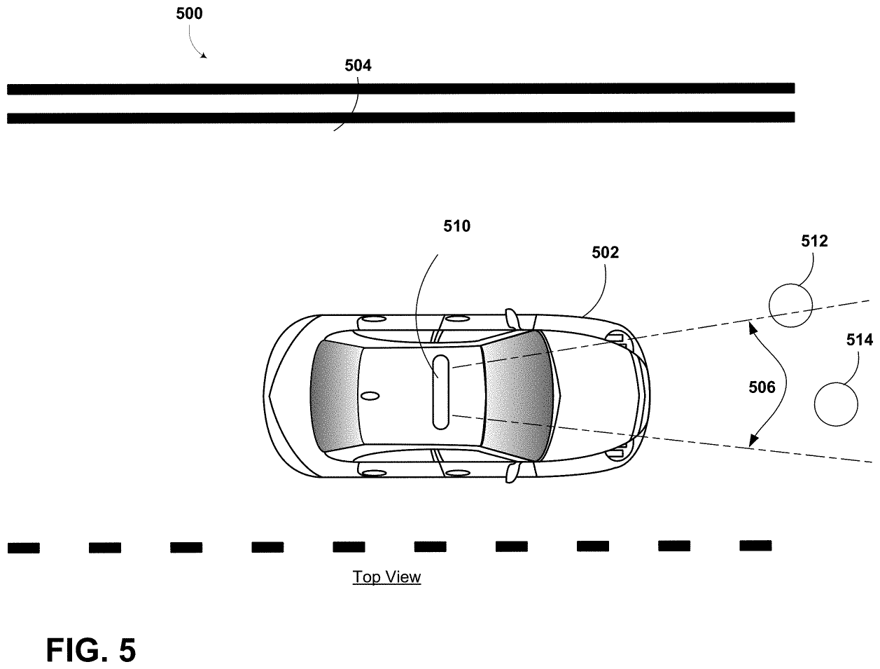

FIG. 5 illustrates an example scenario 500 involving a vehicle 502 traveling down a roadway 504. Vehicle 502 may be operating in an autonomous mode. Further, the vehicle 502 may be configured with a sensor unit 510. In one example, the sensor unit 510 may have a sensor, such as a camera, that has a field of view 506. The field of view 506 may correspond to a region of where the camera may be able to capture an image. In another implementation, sensor unit 510 may include a radar unit. The field of view 506 may correspond to a region over which the radar unit may send and receive signals. In other implementations, the field of view 506 may not be limited to a single region in front of the vehicle, but instead may correspond to the entire region (e.g., 360-degrees) around the vehicle. FIG. 5 illustrates an example scenario 500 in which the sensor unit uses a camera to obtain data about the environment of the vehicle. The description of FIG. 5 can also be used with other sensors, not just an optical sensor like a camera.

As one example implementation, as shown FIG. 5, there may be two environmental objects at least partially within the field of view 506 of a vehicle 502. In this example, it is assumed that the field of view 506 is that of an optical sensor, such as a camera. The camera of the sensor unit 510 may take a picture or video. This picture video will be analyzed to determine objects of the environment.

When the camera in the sensor unit 510 captures a video or image, a first object 514 may fall completely within the field of view 506. A second object 512 may only partially be located within the capture picture or video. When a processing system in the vehicle 502 analyzes the picture or video, it may be able to successfully identify an object, such as the first object 514. However, the processing system may not be able to successfully identify the second object 512 (or it may identify the object 512 with a low confidence). The processing system may not be able to successfully identify the second object 512 for many different reasons. In some implementations, the data of the environment may not include enough information to successfully identify the second object 512 automatically. For example, the second object 512 may be a street sign. An image captured by the vehicle may have a portion of the street sign cut off. The detection system of the vehicle may not be able to correctly identify the cut off street sign. In another example, an object may be partially obscured, so automatic identification may not work accurately. In still another implementation, an object may be deformed or damaged in such a way that the detection system of the vehicle may not be able to accurately detect the object.

Thus, the processing system may communicate data associated with the captured image or video to the remote computing system for remote operation. When a remote operator views the resulting image or video, he or she may be able to successfully identify the second object 512, despite the second object 512 only partially being in the field of view 506. The human operator may be able to take control and remotely drive the vehicle as needed.

Although FIG. 5 is described with respect to pictures and video, the sensor unit 510 may have other sensors, which capture data that is not visible light. Therefore, the disclosed methods and apparatuses are not limited to just optical data collection. Additionally, the identification shown in FIG. 5 was described as having a misidentification due to the second object 512 only partially being within the field of view. In some implementations, a misidentification can occur even though the full object is located in an image or video.

FIG. 6 is a flow chart of a method, according to an example implementation. Methods 600 represents example methods that may include one or more operations as depicted by one or more of blocks 602-610, each of which may be carried out by any of the systems shown in FIGS. 1-5, among other possible systems. In an example implementation, a computing system such as remote computing system 302 performs the illustrated operations, although in other implementations, one or more other systems (e.g., server computing system 306) can perform some or all of the operations.

Those skilled in the art will understand that the flowcharts described herein illustrates functionality and operations of certain implementations of the present disclosure. In this regard, each block of the flowcharts may represent a module, a segment, or a portion of program code, which includes one or more instructions executable by one or more processors for implementing specific logical functions or steps in the processes. The program code may be stored on any type of computer readable medium, for example, such as a storage device including a disk or hard drive.

In addition, each block may represent circuitry that is wired to perform the specific logical functions in the processes. Alternative implementations are included within the scope of the example implementations of the present application in which functions may be executed out of order from that shown or discussed, including substantially concurrent or in reverse order, depending on the functionality involved, as would be understood by those reasonably skilled in the art. Within examples, any system may cause another system to perform one or more of the operations (or portions of the operations) described below.

In line with the discussion above, a computing system (e.g., remote computing system 302 or server computing system 306) may operate in a remote operation mode as shown by method 600. As shown in FIG. 6, at block 602, the computing system operates by receiving sensor data from the autonomous vehicle. In some other examples, the autonomous vehicle may provide sensor data in the form of image and/or video data to the computing system. The sensor data may also include radar, lidar, sound, and other data captured by the vehicle. In some examples, at least one portion of the communication link between the vehicle and the remote system is a wireless link.

At block 604, the computing system operates by determining a latency of a communication link. The latency of the communication link may be determined in various ways. The latency may measure the time a round trip communication takes between the vehicle and the remote computing system. In some examples, the vehicle may report a communication latency to the remote computing system. In other examples, the remote computing system may measure the latency itself. In some examples, either the vehicle or the remote computing system may send a ping signal to the other device to measure the latency. In some examples, the latency is continuously measured. In other examples, the latency may be periodically updated and/or measured.

At block 606, the computing system operates by providing at least one rendering to an operator based on the sensor data and the latency, where the rendering is based on a future location of the vehicle. The computing system may provide images or video (i.e. a plurality of images) to an operator. In some other examples, the computing system may provide simulated sensor data along with the simulated video. The images or video provided to the operator may be images or video that are simulated versions of the video or images received from the autonomous vehicle. The simulated video or images provided to the operator may correspond to a version of the images or video that include the location of where the system predicts objects will be after a period of time equal to (or approximately equal to) the latency time. Therefore, in effect, the operator sees images or videos as the operator would see from the vehicle at a future time.

In practice, the system may also display a latency indicator to the remote operator. The latency indicator may allow the remote operator to know the amount of time it takes for signals to be received from (and transmitted to) the vehicle. Additionally, in some examples, if the latency exceeds a predetermined threshold, a latency alert may be communicated to the vehicle. The latency alert may cause the vehicle to alert a person in the vehicle the remote driving may not be possible due to the latency and to prepare to drive the car a human driven mode.

In some examples, the latency threshold may be adjusted based on driving conditions, map data, and/or vehicle route data. The latency threshold may be reduced when there are more vehicles nearby, more pedestrians near by, in an urban area, or when driving conditions are more hazardous. Other examples where the latency threshold may be adjusted are possible as well.

At block 608, the computing system operates by receiving an operator input by way of a user-interface, such as a GUI. The operator may input a response by way of the user interface based on the at least one image that was provided. The user-interface may include various selectable and non-selectable elements for presenting aspects of the at least one image, such as windows, sub-windows, text boxes, and command buttons. The user interface may also contain a vehicle cockpit with a steering wheel, accelerator and brake pedals, and other vehicle controls as well. The operator input may take the form of a control command for the vehicle. The operator input may also be an input that triggers a handoff. The handoff may be a handoff from autonomous mode to remote drive mode, a handoff from remote drive mode to human drive mode, a handoff from human drive mode to remote drive mode, or a handoff from remote drive mode to an autonomous drive mode.

For example, the user-interface may include a window for displaying a simulated video feed from the vehicle. Based on the simulated video the remote operator may be able to drive the vehicle as if the operator was in the driver's seat of the vehicle.

At block 610, in response to receiving an operator input, the computing system operates by providing an instruction to the autonomous vehicle for execution by the autonomous vehicle via a communication link. As previously stated, an operator may provide an input by way of the user interface. The input may be an identification of an object, and instruction for the autonomous vehicle, a description of a situation, and/or other input. In response to receiving the input, the computing system may cause a command to be issued to the autonomous vehicle. The computing system may issue the command over a network so the command is sent to the autonomous vehicle wirelessly.

In some examples, a command may be entered by the operator. In this instance, the computing system may verify that the command is safe, and upon verification, transmit the command to the vehicle. In other instances, the computing system may determine a command based on the operator's input. Once the command is determined, it may be communicated to the autonomous vehicle. The autonomous vehicle may responsively perform the action described by the command once it is received. For example, when the remote operator adjust the controls for the vehicle in the cockpit, a signal may be communicated to the vehicle for the vehicle to execute as if a driver within the vehicle adjusted the control in the same manner.

In some examples, the command may instruct the autonomous vehicle to move. In other examples, the command may instruct the autonomous vehicle to lock or unlock the doors. In yet other examples, the command may instruct the autonomous vehicle to stay in the same position. Various other commands are possible as well.

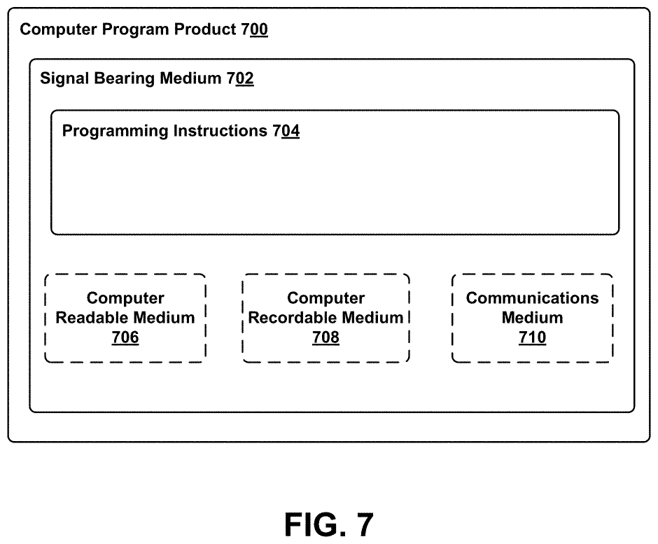

FIG. 7 is a schematic diagram of a computer program, according to an example implementation. In some implementations, the disclosed methods may be implemented as computer program instructions encoded on a non-transitory computer-readable storage media in a machine-readable format, or on other non-transitory media or articles of manufacture.

In an example implementation, computer program product 700 is provided using signal bearing medium 702, which may include one or more programming instructions 704 that, when executed by one or more processors may provide functionality or portions of the functionality described above with respect to FIGS. 1-6. In some examples, the signal bearing medium 702 may encompass a non-transitory computer-readable medium 706, such as, but not limited to, a hard disk drive, a Compact Disc (CD), a digital versatile disk (DVD), a digital tape, memory, components to store remotely (e.g., on the cloud) etc. In some implementations, the signal bearing medium 702 may encompass a computer recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Similarly, the signal bearing medium 702 may correspond to a remote storage (e.g., a cloud). A computing system may share information with the cloud, including sending or receiving information. For example, the computing system may receive additional information from the cloud to augment information obtained from sensors or another entity. Thus, for example, the signal bearing medium 702 may be conveyed by a wireless form of the communications medium 710.

The one or more programming instructions 704 may be, for example, computer executable and/or logic implemented instructions. In some examples, a computing device such as the computer system 112 of FIG. 1 or remote computing system 302 and perhaps server computing system 306 of FIG. 3A may be configured to provide various operations, functions, or actions in response to the programming instructions 704 conveyed to the computer system 112 by one or more of the computer readable medium 706, the computer recordable medium 708, and/or the communications medium 710.

The non-transitory computer readable medium could also be distributed among multiple data storage elements and/or cloud (e.g., remotely), which could be remotely located from each other. The computing device that executes some or all of the stored instructions could be a vehicle, such as vehicle 200 illustrated in FIG. 2. Alternatively, the computing device that executes some or all of the stored instructions could be another computing device, such as a server.

The above detailed description describes various features and operations of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. A method of remote operation a vehicle, the method comprising:
receiving sensor data from the vehicle;
determining a latency of a communication link;
providing at least one rendering to an operator based on the sensor data and the latency, wherein the rendering is based on a future location of the vehicle;
receiving an operator input; and
in response to the operator input, providing an instruction to the vehicle for execution by the vehicle based on the operator input via the communication link.

2. The method of claim 1, wherein the communication link includes at least one wireless link.

3. The method of claim 1, wherein the operator input is a control command for the vehicle.

4. The method of claim 1, wherein receiving an operator input comprises receiving an input from at least one of a steering wheel, a gas pedal, and a brake pedal.

5. The method of claim 1, wherein determining the latency of the communication link comprises reading a latency parameter of the communication link.

6. The method of claim 1, wherein determining the latency of the communication link comprises measuring the latency parameter of the communication link.

7. The method of claim 1, further comprising performing a handoff from an autonomous operation mode to a remote human-operated mode.

8. The method of claim 7, wherein the handoff is performed based on a predetermined route of the vehicle.

9. The method of claim 1, further comprising displaying a latency indicator to the operator.

10. The method of claim 1, further comprising if the latency exceeds a latency threshold communicating a latency alert to the vehicle.

11. The method of claim 1, further comprising generating the rendering by predicting the location of objects and a position of the vehicle after a period of time approximately equal to the latency time.

12. The method of claim 1, wherein:
the sensor data comprises images or video; and
providing at least one rendering to an operator comprises showing the rendering of the image or the video for a future time.

13. A system comprising:
a communication unit configured to communicate with a vehicle via a communication link, wherein the communication unit is configured to:
receive data from the vehicle, the data comprising image data and location data,
communicate instructions to the vehicle for execution by the vehicle; and
a processor configured to:
determine a latency of communication between the system and the vehicle;
provide at least one rendering to an operator based on the data and the latency, wherein the rendering is based on a future location of the vehicle;
receive signals based on an operator input; and
determine an instruction for the vehicle based on the operator input.

14. The system of claim 13, wherein the communication link has at least one wireless link.

15. The system of claim 1132, further comprising operator input hardware comprising at least one of a steering wheel, a gas pedal, and a brake pedal.

16. The system of claim 13, wherein the processor is further configured to display a latency indicator to the operator.

17. The system of claim 13, wherein the processor is further configured to communicate a latency alert to the vehicle if the latency exceeds a latency threshold.

18. An article of manufacture including a non-transitory computer-readable medium having stored thereon instructions that, when executed by a processor cause the processor to perform operations comprising:
receiving sensor data from the vehicle;
determining a latency of a communication link;
providing at least one rendering to an operator based on the sensor data and the latency, wherein the rendering is based on a future location of the vehicle;
receiving an operator input; and
in response to the operator input, providing an instruction to the autonomous vehicle for execution by the autonomous vehicle based on the operator input via the communication link.

19. The article of manufacture of claim 18, wherein:
the communication link includes at least one wireless link;
the operator input is a control command for the vehicle; and
receiving an operator input comprises receiving an input from at least one of a steering wheel, a gas pedal, and a brake pedal.

20. The article of manufacture of claim 18, further comprising:
performing a handoff from an autonomous operation mode to a remote human-operated mode, wherein the handoff is performed based on a predetermined route of the vehicle; and
generating the rendering by predicting the location of objects and a position of the vehicle after a period of time approximately equal to the latency time.
